(19) United States
(12) Patent Application Publication
(10) Pub. No.: US 2019/0318190 A1
(43) Pub. Date: Oct. 17, 2019

(54) INFORMATION PROCESSING APPARATUS, AND NON-TRANSITORY COMPUTER READABLE MEDIUM

(71) Applicant: FUJI XEROX CO., LTD., Tokyo (JP)

(72) Inventors: Genki OSADA, Kanagawa (JP); Raghava KRISHNAN, Kanagawa (JP)

(73) Assignee: FUJI XEROX CO., LTD., Tokyo (JP)

(21) Appl. No.: 16/378,578

(22) Filed: Apr. 9, 2019

(30) Foreign Application Priority Data
Apr. 17, 2018 (JP) 2018-078880

(51) Int. Cl. G06K 9/34; G06F 17/22; G06F 16/33

(52) U.S. Cl. CPC G06K 9/344; G06F 16/3344; G06F 16/3337; G06F 17/2217

(57) ABSTRACT

An information processing apparatus includes a character recognition unit that recognizes a character included in image information and outputs character information, a searching unit that searches for a character string in the character information output from the image information, in accordance with search instruction information that instructs the character string including at least one character included in the image information to be searched for and association information that associates in advance a first character serving as an input target to the character recognition unit with a second character that is output when the character recognition unit recognizes the first character, and a correcting unit that corrects the character string hit in searching, based on the association information.

### CROSS-REFERENCE TO RELATED APPLICATIONS

This application is based on and claims priority under 35 USC 119 from Japanese Patent Application No. 2018-078880 filed Apr. 17, 2018.

### BACKGROUND

### Technical Field

The present invention relates to an information processing apparatus, and a non-transitory computer readable medium.

### SUMMARY

According to an aspect of the invention, there is provided an information processing apparatus. The information processing apparatus includes a character recognition unit that recognizes a character included in image information and outputs character information, a searching unit that searches for a character string in the character information output from the image information, in accordance with search instruction information that instructs the character string including at least one character included in the image information to be searched for and association information that associates in advance a first character serving as an input target to the character recognition unit with a second character that is output when the character recognition unit recognizes the first character, and a correcting unit that corrects the character string hit in searching, based on the association information.

### BRIEF DESCRIPTION OF THE DRAWINGS

Exemplary embodiment of the present invention will be described in detail based on the following figures, wherein:

FIG. 1 is a block diagram illustrating a control system in an information processing system of an exemplary embodiment;

FIG. 2 illustrates an example of an erroneous recognition pattern table;

FIG. 3A and FIG. 3B illustrate examples of a search character string input screen; and

FIG. 4 is a flowchart illustrating a process of an information processing apparatus of FIG. 1.

### DETAILED DESCRIPTION

Exemplary embodiment of the present invention is described in connection with the drawings. In the drawings, elements identical in functionality are designated with the same reference numeral and the discussion thereof is not duplicated.

According the exemplary embodiment of the present invention, an information processing apparatus includes a character recognition unit that recognizes a character included in image information and outputs character information, a searching unit that searches for a character string in the character information output from the image information, in accordance with search instruction information that instructs the character string including at least one character included in the image information to be searched for and association information that associates in advance a first character serving as an input target to the character recognition unit with a second character that is output when the character recognition unit recognizes the first character, and a correcting unit that corrects the character string hit in searching, based on the association information.

The “image information” is, for example, digital data of a document, a photograph, a drawing, or the like. The “character recognition unit” includes a unit that performs an optical character recognition (OCR) process to recognize a character or a character string from the image information, and then outputs the character information. The “first character” corresponds to a character that serves as an input target to the character recognition unit. The “second character” is a character that serves as an output target of the character recognition unit responsive to the first character, namely, the “second character” is output when the character recognition unit recognizes the first character. The “association information” is information that associates the first character with the second character. The “character string” includes one or more characters.

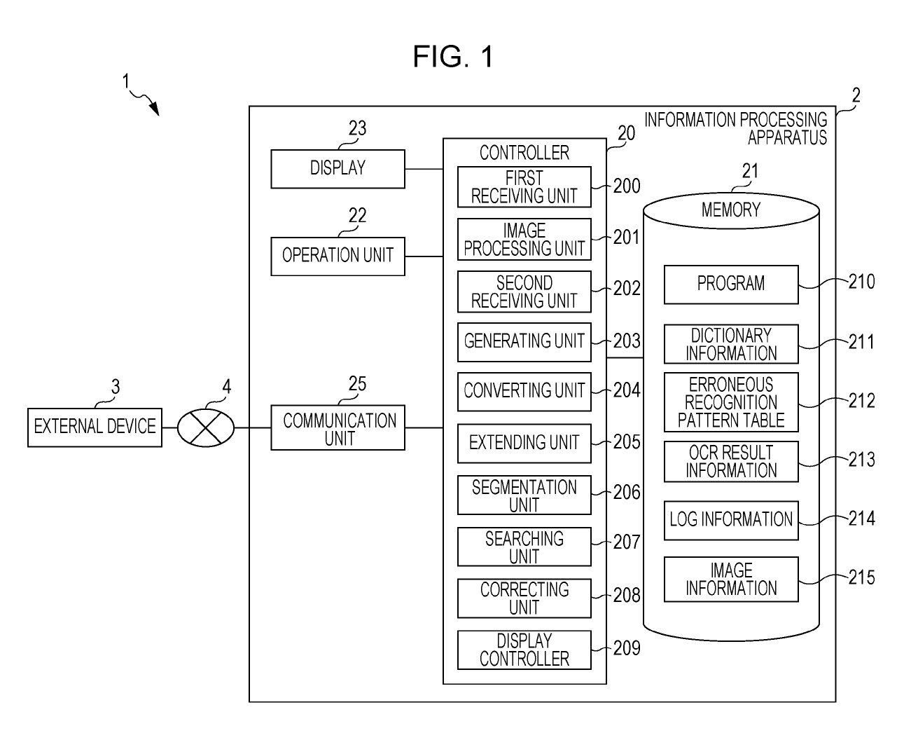

FIG. 1 is a block diagram illustrating a control system in an information processing system 1 of an exemplary embodiment. The information processing system 1 includes an information processing apparatus 2, and an external device 3 connected to the information processing apparatus 2 via a network 4. For example, the information processing apparatus 2 may be a personal computer, a tablet terminal, or a multi-function portable phone (smart phone).

The external device 3 may include a personal computer or a server apparatus. The network 4 may be a local area network (LAN), the Internet, and/or a wide area network, and may be a wired or wireless system.

The information processing apparatus 2 includes a controller 20 that controls each element of the information processing apparatus 2, a memory 21 that stores a variety of data, an operation unit 22 that includes a keyboard, a mouse, and the like, a display 23 that includes a liquid-crystal display or the like, and a communication unit 25 that transmits or receives a signal to or from the external device 3 via the network 4. The operation unit 22 and the display 23 may be integrated into an operation and display unit in a unitary body (not illustrated).

The controller 20 includes a central processing unit (CPU), an interface, and the like. The CPU operates in accordance with a program 210 stored on the memory 21, and thus implements the functionalities of a first receiving unit 200, an image processing unit 201, a second receiving unit 202, a generating unit 203, a converting unit 204, an extending unit 205, a segmentation unit 206, a searching unit 207, a correcting unit 208, a display controller 209, and the like. The image processing unit 201 is an example of the character recognition unit. The generating unit 203 and the converting unit 204 are an example of an identifying unit. Each of the first receiving unit 200 through the display controller 209 is described in detail below.

The memory 21 includes a read only memory (ROM), a random-access memory (RAM), and a hard disk, and stores a variety of information including a program 210, dictionary information 211, an erroneous recognition pattern table 212, OCR result information 213, log information 214, and image information 215. The dictionary information 211 is dictionary data into which a pattern of a character used in optical character recognition (OCR) is organized. The OCR result information 213 is related to the results of the OCR process. The log information 214 and the image information 215 are described below.

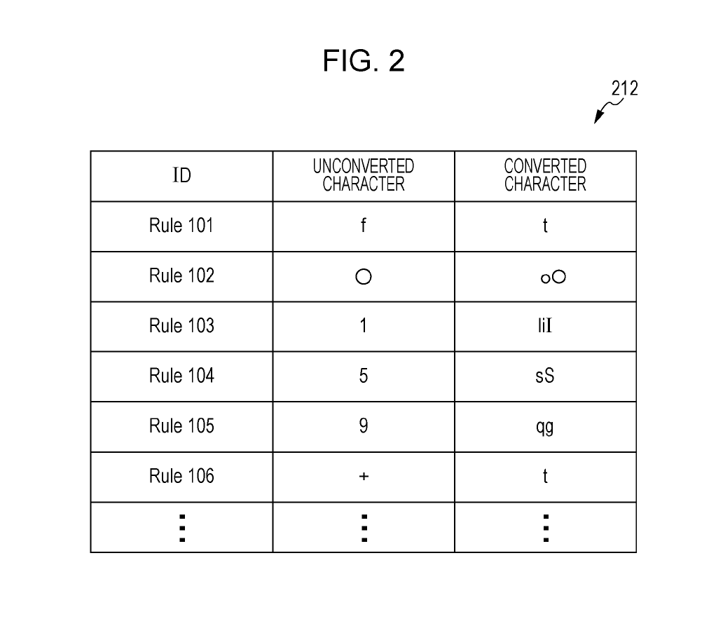

FIG. 2 illustrates an example of the erroneous recognition pattern table 212. The erroneous recognition pattern table 212 includes an identity (ID) column, an “unconverted character” column, and a “converted character” column.

The ID column records ID information that identifies a pattern of error recognition (also referred to as an “erroneous recognition pattern” or a “rule”). The erroneous recognition pattern refers to a pair of an unconverted character described below and at least one converted character corresponding to the unconverted character. The “unconverted character” column records a character that serves as a target to be input to the image processing unit 201. The characters recorded in this column include a character that is the one erroneously recognized in the past, and a character that is still likely to be erroneously recognized. The unconverted character is an example of the first character. In the following discussion, erroneous character recognition as a different character is simply referred to as “erroneous recognition”.

The “converted character” column stores a character that is output when the image processing unit 201 in the information processing apparatus 2 recognizes a character recorded in the “unconverted character” column. The characters recorded in the column include a character that is the one erroneously recognized in the past, and a character that is still likely to be erroneously recognized (hereinafter referred to as a “recognition error susceptible character”). The recognition error susceptible character may be a character similar in shape to a search target character. If there are multiple recognition error susceptible characters, they may be arranged in succession, and may be recorded in a delimited form using a delimiter, such as “,”. The recognition error susceptible character is an example of the second character. In the context of this specification, the word “record” is intended to mean writing information in table and the word “store” is intended to mean writing information on the memory 21.

Referring to FIG. 2, the letter “f” and the symbol “+” are character examples erroneously recognized in the past as “t”, or are currently likely to be erroneously recognized as “t” (see Rule 101 and Rule 106). As another example, the zero “0” is the character erroneously recognized in the past as the alphabet lowercase letter “o” or the alphabet uppercase latter “O”, or are currently likely to be erroneously recognized as s the alphabet lowercase letter “o” or the alphabet uppercase latter “O” (see Rule 102). The combination of “f” and “t” (pair), and the combination of “+” and “t” (pair), or the combination of “0” and “o or O” (pair) is an example of the recognition error pattern or rule.

The erroneous recognition pattern table 212 is an example of first association information that associates the first character with the second character. The erroneous recognition pattern table 212 may be appropriately updated by adding information that is input by an operator from the outside, or by adding information acquired through a learning functionality, such as deep learning.

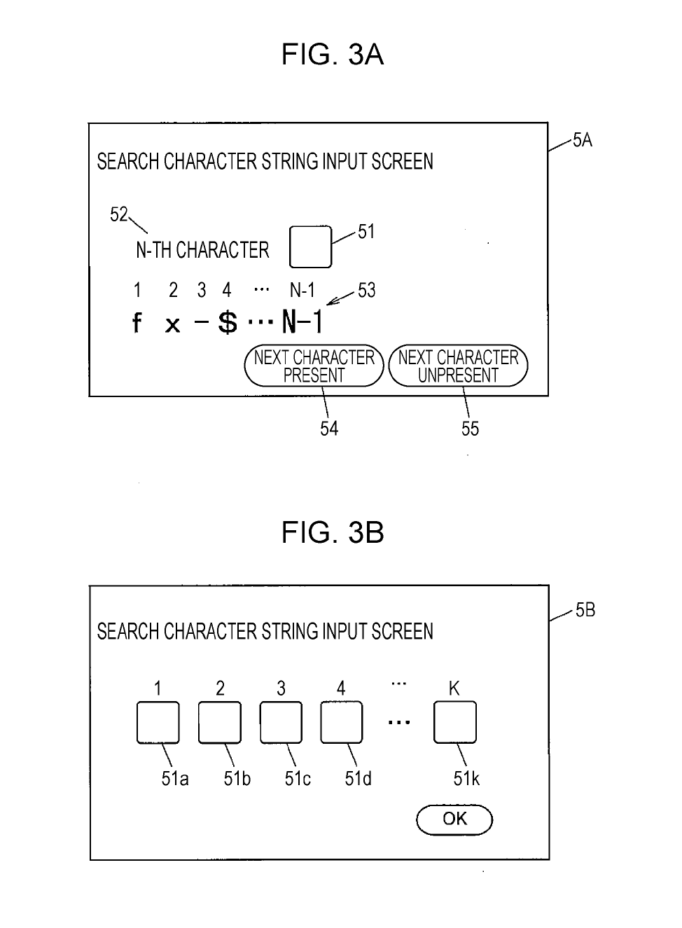

The image information 215 is described in connection with FIG. 3A and FIG. 3B. FIG. 3A and FIG. 3B illustrate examples of a search character string input screen. Referring to FIG. 3A, a search character string input screen 5A includes a character input box 51 that receives a character, number information 52 that indicates what character is currently being input, a character string display screen 53 that indicates, as a character string, characters heretofore input, a first button 54 to cause a next character to be input, and a second button 55 that causes the inputting of characters to be completed.

FIG. 3B illustrates as another example a search character string input screen 5B. The search character string input screen 5B includes multiple character input boxes 51a, 51b, 51c, 52d, . . . , 51k.

Elements forming the controller 20 are described in detail below. The first receiving unit 200 receives image information (hereinafter referred to as “image data”) transmitted from the external device 3. The image data is digital data including a document, a photograph, and/or graphics. More specifically, the digital data includes graphic information including a design drawing, a circuit diagram, a symbol, a schematic diagram, an emoji, and/or a symbol mark, and character information including a character and a character string. The image data may be too large in data size for all characters in a whole area of the image data to be read through a single character recognition process.

The “character” represents any meaning or content in a given language. For example, the character may be a number, or an ideogram, such as Kanji letters, or a phonogram, such as Japanese Kana letters or English alphabet. The “symbols” include a decoration symbol, a drafting symbol, a circuit symbol, a map symbol, and a weather chart symbol.

Particular symbols, such as Dollar mark “$”, comma “,”, and hyphen “−” may be included as characters rather than as symbols. The particular characters included as characters (hereinafter referred to as “symbolic characters”) correspond to symbols that may be entered as text information using a keyboard. The characters may be a type or a hand-written character.

The image processing unit 201 performs on the image data received by the first receiving unit 200 a shape recognition process to recognize a shape of a graphic included in the image data and a character recognition process to recognize a character or a character string included in the image data.

The character recognition process includes an optical character recognition (OCR) process in which a pattern of a character is extracted from the image data on a per character basis, the pattern of the character is compared with a pattern of a character recorded in the dictionary information 211 on the memory 21, using a pattern matching technique, and a character having the highest similarity is output as a result. Results obtained through the OCR process are referred to as “OCR results”.

The OCR results include character information indicating a character and a character string recognized through the OCR process, and location information indicating the location of the recognized character or character string in the image. The location information includes coordinate values on an image, for example. The image processing unit 201 stores the output OCR results in a text format as the OCR result information 213 on the memory 21.

The second receiving unit 202 receives search instruction information that instructs a character string including at least one character to be searched for in response to an operation performed on the operation unit 22 by an operator. The search instruction information includes information indicating a character string that serves as a target to be searched for in the image data. The search instruction information is input through an operation that specifies characters forming the character string one by one. The operation may be performed in an interactive manner through a user interface (see FIG. 3A), or may be performed in a non-interactive manner by using a screen including multiple input boxes. Characters may be input in each of the input boxes with one character input in an input box at a time (see FIG. 3B).

The generating unit 203 generates a search query in a predetermined format in accordance with the search instruction information received by the second receiving unit 202. The search query is constructed by combining elements listed in Table 1.

TABLE 1

| Name of | | |
|---|---|---|
| element | Contents | Symbol example |
| Fixed | Specifying character that | [x] |
| character | is included in part or | x represents fixed |
| element | whole of character string | character. |
| | in fixed way (hereinafter | |
| | referred to as fixed | |
| | character) | |
| Multiple | Specifying multiple | [x, y, z, . . .] |
| specifying | character candidates | x, y, and z |
| element | included at particular | represent character |
| candidates | location of character | candidates. |
| | string | |
| Range | specifying range of numeral | [I-J] |
| specifying | included at particular | I and J are |
| element | location in character | integers, and symbol |
| | string | indicates range |
| | | between I and J. |
| Wildcard | Specifying that character | [ ] |
| element | included at particular | |
| | location in character | |
| | string may be any character | |
| Number of | Specifying range of number | {min = N, max = M} |
| repetition | of characters succeeding to | N and M are |
| element | character included at | integers, and symbol |
| | particular location in | indicates that |
| | character string | characters with the |
| | | number of which |
| | | falls within range |
| | | of from N to M |
| | | appear |
| | | consecutively. |

Table 1 lists examples of search queries and the exemplary embodiment is not limited to these.

If the second receiving unit 202 receives the search instruction information to search for a character string “fx”, such as “afx12345”, “fx111”, or “11fx11”, the generating unit 203 generates a search query, such as “[ ] [ ][f] [x]”.

As another example, the second receiving unit 202 receives the search instruction information to search for a character string that includes and starts with “f” or “t” that is followed by “x”, and then followed by two to four consecutive numerals, each falling within a range of 1 to 3, such as “fx123” or “tx11”, the generating unit 203 generates a search query “[f,t] [x] [1-3] {min=2, max=4}”, for example.

As another example, if the second receiving unit 202 receives the search instruction information to search for a character string including a symbolic character at a particular location, such as “fx-1$x” or “fx-3$x”, the generating unit 203 generates a search query, such as “[f] [x] [−] [0-3] {min=1, max=1} [$] [x]”.

For convenience of explanation, the character string includes all half-width letters, but the character string may include some or all full-width letters. The character string is not limited to English alphabets. The character string may include other language letters, such as Japanese Hiragana letters, Japanese Katakana letters, and Kanji letters. The same is true of the character strings described below.

The converting unit 204 converts the search query generated by the generating unit 203 into a search query in a standard expression. The standard expression refers to an expression that is standardized for searching a character string.

The converting unit 204 converts each element forming the search query to a standard expression. More specifically, the converting unit 204 removes comma “,” from multiple specifying element candidates of the search query, removes hyphen “−” from the multiple specifying element candidates, removes “min=” and “max=” from the number of repetition element, and substitutes an asterisk mark “*” for a blank of the wildcard element.

If the search query includes a symbolic character, the converting unit 204 places an escape mark, such as yen mark ¥, to the right of the symbolic character. Table 2 lists the correspondence relationship between the elements of the search query and the standard expression.

TABLE 2

| Name of search | | |
|---|---|---|
| query | Search query | Standard expression |
| Fixed character | [x] | [x] |
| element | | (Unchanged) |
| Symbolic character | Examples | [¥$] |
| included | [$] | [¥,] |
| | [,] | [¥-] |
| | [-] | |
| Multiple specifying | [x, y, z, . . .] | [xyz. . .] |
| element candidates | | |
| Range specifying | [I-J] | [I-J] |
| element | | (Unchanged) |
| Wildcard element | [ ] | [*] |
| Number of | [min = N, max = M] | {N, M} |
| repetition element | | |

Table 2 lists an example of the correspondence relationship, and the exemplary embodiment is not limited to these examples.

As an example, the converting unit 204 converts a search query “[ ] [ ] [f] [x]” into a standard search query “[*] [*] [f] [x]”. As another example, the converting unit 204 converts a search query “[f,t] [x] [1-3] {min=2, max=4}” into a search query “[ft] [x] [1-3] [2, 4]”. Yet as another example, the converting unit 204 converts a search query “[f] [x] [−] [0-3] {min=1, max=1} [$] [x]” into a search query “[f] [x] [Y-] [0-3] {1, 1} [Y$] [x]”. If the same number is consecutively arranged like {1,1}, the element may be simply represented by {1}.

The extending unit 205 extends the standard expression by applying an erroneous recognition pattern recorded in the erroneous recognition pattern table 212 on the memory 21 on the standard expression converted by the converting unit 204. Specifically, the extending unit 205 extends the standard expression such that a range for the character string serving as a target to be searched in the OCR result information 213 by the searching unit 207 covers character strings including converted characters recorded in the erroneous recognition pattern table 212.

More specifically, if an unconverted character string recorded in the erroneous recognition pattern table 212 is included in the standard expression converted by the converting unit 204, the extending unit 205 extends the standard expression by adding a converted character associated with the unconverted character in the erroneous recognition pattern table 212. The extending unit 205 stores in the log information 214 on the memory 21 an ID of the erroneous recognition pattern applied when the standard expression is extended, in association with the location of the character in the character string to which the erroneous recognition pattern is applied. The location in the character string indicates where the character is located in the character string, namely, the location of the character in the character string. The log information 214 is an example of second association information.

As an example, the standard expression “[fg] [x] [1-3] {2,4}” includes “f” and “1”, recorded as unconverted characters in the erroneous recognition pattern table 212. In such a case, the extending unit 205 extends element “[fg]” to “[ftg]” by applying “Rule 101” in the erroneous recognition pattern table 212 to “f”, and extends element “[1-3]” to “[1-3 iI]” by applying “Rule 103” in the erroneous recognition pattern table 212 to “1”. As a result, the extending unit 205 extends the standard expression converted by the converting unit 204 “[fg] [x] [1-3] {2,4}” to “[ftg] [x] [1-3|iI] {2,4}”.

Through the extension described above, the range of the character string serving as a target for search in the OCR result information 213 is extended as listed in Table 3.

TABLE 3

| Before extension | | | After extension | | |
|---|---|---|---|---|---|
| [fg][x][1-3]{2, 4} | | | [ftg] [x] [1-3\|iI]{2, 4} | | |
| | | third and | | | third and |
| | | subse- | | | subse- |
| first | second | quent | first | second | quent |
| char- | char- | char- | char- | char- | char- |
| acter | acter | acters | acter | acter | acters |
| f or g | x | 1, 2 or 3 | f, t | x | 1, 2, 3, \|, |
| | | forms two | or g | | i, or \| |
| | | to four | | | forms two |
| | | consecutive | | | to four |
| | | letters | | | consecutive |
| | | | | | letters |

The extending unit 205 stores, in the log information 214 on the memory 21, the erroneous recognition pattern applied when the standard expression is extended, in association with the location of the character to which the erroneous recognition pattern is applied in a form, such as “[Rule 101] [ ] [Rule 103] [ ]”.

The segmentation unit 206 generates multiple search queries by segmenting a single search query if the search query satisfies a predetermined condition. The “predetermined condition” is that the search query includes multiple specifying element candidates and a range specifying element, and multiple erroneous recognition patterns corresponding to the converted character are applied.

As an example, if a search query includes multiple specifying element candidates, such as [f,+] including “[f,+] [x]”, Rule 101 is applied to “f”, and Rule 102 is applied to “+”. In the two erroneous recognition patterns, each of “f” and “t” is associated with the same converted character “t”. In such a case, the segmentation unit 206 segments the single search query “[f,+] [x]” into a first search query “[f] [x]” and a second search query “[+] [x]” in advance.

The searching unit 207 applies the standard expression extended by the extending unit 205 on the OCR results recorded in the OCR result information 213 on the memory 21, and searches for a character string responsive to the extended standard expression in the character information included in the image data.

The correcting unit 208 corrects the character string searched and hit by the searching unit 207. More specifically, the correcting unit 208 references the log information 214 stored on the memory 21. If a character detected in response to the standard expression extended by the extending unit 205 is included in the character string hit by the searching unit 207 in the character information included in the image data, in other words, if the recognition error susceptible character is added at a particular location by the extending unit 205, then the correcting unit 208 corrects the character string by applying the erroneous recognition pattern, applied to each character by the extending unit 205, in a reverse direction.

The display controller 209 references the image information 215 on the memory 21, and performs control such that a screen to input the character string forming the search instruction information is displayed to the operator on the display 23.

In response to the operator's operation on a first button 54, the display controller 209 performs control to update number information 52 to a next number, and to display on the display 23 the search character string input screen 5A on which the next character entered on the character string display screen 53 is added. In order to enter a character string one character by one character in an interactive manner, the display controller 209 may perform control such that the search character string input screen 5A is alternately displayed each time the second receiving unit 202 receives one character. Referring to FIG. 3B, the display controller 209 may perform control such that the search character string input screen 5B including the multiple character input boxes 51a, 51b, 51c, 52d, . . . , 51k is displayed on the display 23.

The display controller 209 performs control such that the character string corrected by the correcting unit 208 is displayed on the display 23 in emphasis, for example, by marking the character string.

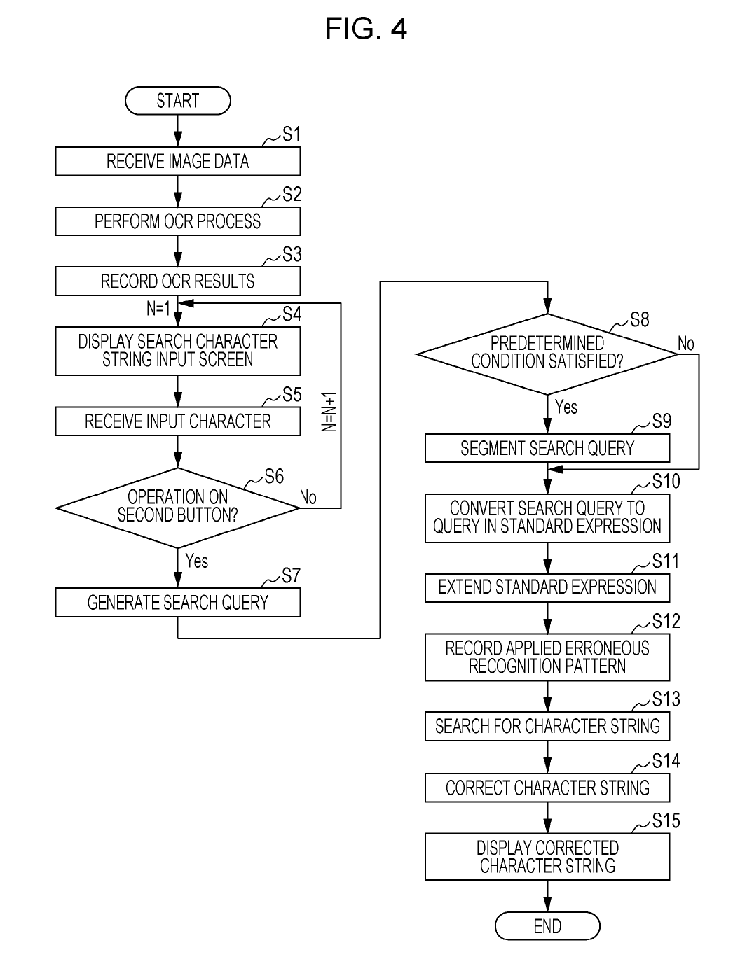

A process of the information processing apparatus 2 is described with reference to FIG. 4. FIG. 4 is a flowchart illustrating the process of the information processing apparatus 2. As an example, a character string “fx20991” is searched in an image.

The first receiving unit 200 receives the image data from the external device 3 (S1), and transfers the received image data to the image processing unit 201. The image processing unit 201 performs the OCR process on the image data received by the first receiving unit 200 (S2), and outputs the OCR results including the character information from the image data. The image processing unit 201 records the output OCR results in the OCR result information 213 on the memory 21 (S3).

The display controller 209 performs control to display the search character string input screen 5A of FIG. 3A on the display 23 (S4). The display controller 209 performs control to display 1 as N.

When the operator performs an operation on the operation unit 22 to enter a character in the character input box 51 on the search character string input screen 5A, the second receiving unit 202 receives information on the input character (S5). The information on the input character is one of elements forming the search instruction information.

The operations in two steps S4 and S5 are iterated until the operator operates a second button 55 (no branch from S6). More specifically, when the operator performs an operation on the first button 54 on the search character string input screen 5A, the display controller 209 performs control to update “N” to the next number “N+l” of the number information 52 and to display the search character string input screen 5A that includes the character string display screen 53 with the character string heretofore entered and added to. The second receiving unit 202 receives information on a character entered next.

If the operator operates the second button 55 (yes branch from S6), the generating unit 203 generates a search query, based on the information on at least one character received by the second receiving unit 202, namely, based on the search instruction information (S7). As an example, if the operator enters “f”, “x”, “2”, “0”, “9”, “9”, and “1”, the generating unit 203 generates a search query “[f] [x] [0-9] {min=5, max=5}”.

If the search query satisfies the predetermined condition (yes branch from S8), the segmentation unit 206 segments the search query (S9).

The converting unit 204 converts the search query generated by the generating unit 203 to a search query in the standard expression (S10). For example, the converting unit 204 converts a search query “[f] [x] [0-9] {min=5, max=5}” to a search query “[f] [x] [0-9] {5}” in the standard expression.

The extending unit 205 references the erroneous recognition pattern table 212 stored on the memory 21, and extends the standard expression converted by the converting unit 204 (S11). As an example, the extending unit 205 extends the search query “[f] [x] [0-9] {5}” in the standard expression to a search query “[ft] [x] [0-9oO|iIsSqg] {5}”.

The extending unit 205 records in the log information 214 on the memory 21 an erroneous recognition pattern in association with the location of the character (S12). As an example, the extending unit 205 records in the log information 214 “[Rule 101] [ ] [Rule 102, Rule 103, Rule 104, Rule 105] { }”.

The searching unit 207 searches for a corresponding character string from the character information included in the image data by applying the standard expression extended by the extending unit 205 on the OCR results (S13). As an example, the searching unit 207 searches for a character string “tx2.gqi” in the OCR result information 213 using the extended standard expression (“[ft] [x] [0-9oO|iIsSgq] {5}”).

The correcting unit 208 corrects the character string searched and hit by the searching unit 207 using the log information 214 and the erroneous recognition pattern table 212 (S14). As an example, the correcting unit 208 applies Rule 101 in a reverse direction to the first letter “t” of “tx2.gqi” searched and hit by the searching unit 207, thereby replacing “t” with “f”. The correcting unit 208 applies Rule 102 in a reverse direction to the third letter “.” of “tx2.gqi”, thereby replacing “.” with “0 (zero)”. The correcting unit 208 applies Rule 103 in a reverse direction to the fourth letter “g” of “tx2.gqi”, thereby replacing “g” with “9”. The correcting unit 208 applies Rule 104 in a reverse direction to the fifth letter “q” of “tx2.gqi”, thereby replacing “q” with “9”. The correcting unit 208 applies Rule 105 in a reverse direction to the sixth letter “i” of “tx2.gqi”, thereby replacing “i” with “1”. The correcting unit 208 thus corrects “tx2.gqi” to “fx29901”.

The display controller 209 performs control to display the character string “fx29901” in the corrected form on the display 23 by marking, for example (S15).

In the example described above, the search query “[f] [x] [0-9] {min=5, max=5}” is not segmented by the segmentation unit 206. If the search query is segmented by the segmentation unit 206, the operations in step S10 thereafter are performed on each of the segmented queries.

The exemplary embodiment of the present invention has been described. The present invention is not limited to the exemplary embodiment described above. A variety of changes and modifications are possible in the exemplary embodiment without departing from the scope of the present invention. For example, the first receiving unit 200 may receive the OCR results instead of the image data, by performing the OCR process on the image data in advance.

The image data is not limited to image data transmitted from the external device 3. For example, an imaging unit (not illustrated) may be mounted in the information processing apparatus 2, and the image data may be obtained from the imaging unit that has photographed an image. The segmentation unit 206 segments the search query. Alternatively, the segmentation unit 206 may segment the standard expression.

Each element in the controller 20 may be implemented using a hardware circuit, such as a reconfigurable field programmable gate array (FPGA) or an application specific integrated circuit (ASIC).

Some of the elements of the exemplary embodiment may be omitted or modified as long as such a modification does not change the scope of the present invention. Without departing from the scope of the present invention, a new step may be added, one of the steps may be deleted or modified, and the steps may be interchanged therebetween. The program used in the exemplary embodiment may be supplied in a recorded form on a computer readable recording medium, such as a compact disk read only memory (CD-ROM). The program may be stored on an external server, such as a cloud server, and may be used via a network.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a character recognition unit that recognizes a character included in image information and outputs character information;
a searching unit that searches for a character string in the character information output from the image information, in accordance with search instruction information that instructs the character string including at least one character included in the image information to be searched for and association information that associates in advance a first character serving as an input target to the character recognition unit with a second character that is output when the character recognition unit recognizes the first character; and
a correcting unit that corrects the character string hit in searching, based on the association information.

2. The information processing apparatus according to claim 1, further comprising an extending unit that, if the first character is included in the character string, extends a range for the character string that the searching unit searches for in the character information by adding the second character corresponding to the first character in accordance with the association information.

3. The information processing apparatus according to claim 2, where if the association information is first association information, the correcting unit corrects the hit character string in accordance with second association information that associates a location of the first character in the character string with a combination of the first character and the added second character.

4. The information processing apparatus according to claim 1, further comprising a segmentation unit that segments the range for the character string if the search instruction information satisfies a predetermined condition.

5. The information processing apparatus according to claim 2, further comprising a segmentation unit that segments the range for the character string if the search instruction information satisfies a predetermined condition.

6. The information processing apparatus according to claim 3, further comprising a segmentation unit that segments the range for the character string if the search instruction information satisfies a predetermined condition.

7. The information processing apparatus according to claim 4, wherein the segmentation unit segments the range for the character string if the predetermined condition that the association information includes a plurality of the first characters corresponding to the second character is satisfied.

8. The information processing apparatus according to claim 5, wherein the segmentation unit segments the range for the character string if the predetermined condition that the association information includes a plurality of the first characters corresponding to the second character is satisfied.

9. The information processing apparatus according to claim 6, wherein the segmentation unit segments the range for the character string if the predetermined condition that the association information includes a plurality of the first characters corresponding to the second character is satisfied.

10. The information processing apparatus according to claim 1, further comprising a receiving unit that receives characters forming the search instruction information one by one.

11. The information processing apparatus according to claim 2, further comprising a receiving unit that receives characters forming the search instruction information one by one.

12. The information processing apparatus according to claim 3, further comprising a receiving unit that receives characters forming the search instruction information one by one.

13. The information processing apparatus according to claim 4, further comprising a receiving unit that receives characters forming the search instruction information one by one.

14. The information processing apparatus according to claim 5, further comprising a receiving unit that receives characters forming the search instruction information one by one.

15. The information processing apparatus according to claim 6, further comprising a receiving unit that receives characters forming the search instruction information one by one.

16. The information processing apparatus according to claim 7, further comprising a receiving unit that receives characters forming the search instruction information one by one.

17. The information processing apparatus according to claim 8, further comprising a receiving unit that receives characters forming the search instruction information one by one.

18. The information processing apparatus according to claim 9, further comprising a receiving unit that receives characters forming the search instruction information one by one.

19. A non-transitory computer readable medium storing a program causing a computer to execute a process for processing information, the process comprising:
recognizing a character included in image information and outputting character information;
searching for a character string in the character information output from the image information, in accordance with search instruction information that instructs the character string including at least one character included in the image information to be searched for and association information that associates in advance a first character serving as an input target to the character recognition unit with a second character that is output when the first character is recognized; and
correcting the character string hit in searching, based on the association information.

20. An information processing apparatus comprising:
character recognition means for recognizing a character included in image information and outputs character information;
searching means for searching for a character string in the character information output from the image information, in accordance with search instruction information that instructs the character string including at least one character included in the image information to be searched for and association information that associates in advance a first character serving as an input target to the character recognition means with a second character that is output when the character recognition means recognizes the first character; and
correcting means for correcting the character string hit in searching, based on the association information.
